(19) United States
(12) Patent Application Publication
(10) Pub. No.: US 2025/0188622 A1
(43) Pub. Date: Jun. 12, 2025

(54) METHODS AND SYSTEM OF GRAPHITIC CARBON AND HYDROGEN PRODUCTION BY MICROWAVE PYROLYSIS OF NATURAL GAS, CHEMICAL TREATMENT AND ELECTROCHEMICAL CONVERSION

(71) Applicant: Battelle Memorial Institute, Columbus, OH (US)

(72) Inventors: Jagannathan MAHADEVAN, Columbus, OH (US); Philip KESTER, Midland, MI (US); Michael HEINRICHS, Dublin, OH (US); Satya P. CHAUHAN, Powell, OH (US)

(73) Assignee: BATTELLE MEMORIAL INSTITUTE, Columbus, OH (US)

(21) Appl. No.: 18/973,752

(22) Filed: Dec. 9, 2024

Related U.S. Application Data
(60) Provisional application No. 63/608,152, filed on Dec. 8, 2023.

(51) Int. Cl. C25B 1/135; C01B 3/24; C01B 32/05; C25B 11/043

(52) U.S. Cl. CPC C25B 1/135; C01B 3/24; C01B 32/05; C25B 11/043; C01B 2203/0277; C01B 2203/06; C01B 2203/1041; C01B 2203/1241

(57) ABSTRACT

A system and method for producing graphitic carbon, with the method including generating amorphous carbon by microwave pyrolysis of a natural gas feedstock in the presence of a carbon catalyst; treating the amorphous carbon with an oxidizing agent to introduce oxygen functionalities; and converting the treated amorphous carbon to graphitic carbon through electrochemical methods.

### CROSS-REFERENCE TO RELATED APPLICATIONS

The present application claims the benefit of U.S. Provisional Application No. 63/608,152, titled “METHODS AND SYSTEM OF CARBON & HYDROGEN PRODUCTION BY MICROWAVE PYROLYSIS OF NATURAL GAS AND ELECTROCHEMICAL CONVERSION” filed Dec. 8, 2023, the content of which is incorporated herein by reference in its entirety for all purposes.

### TECHNICAL FIELD

The present disclosure pertains to the field of advanced graphite production technologies, specifically focusing on innovative methods and systems for producing graphitic carbon and hydrogen. This invention relates to a novel process integrating microwave pyrolysis of natural gas, chemical treatment and electrochemical conversion techniques

### STATEMENT OF FEDERALLY FUNDED RESEARCH

None.

### BACKGROUND

Graphite is increasingly recognized as a critical mineral due to its essential role in the burgeoning fields of battery technology and fuel cell development. The ongoing advancements in the hydrogen economy and the shift towards electric transportation heavily rely on the use of these electrochemical conversion devices. As such, the demand for graphite is expected to rise in parallel with these technological developments. However, the United States faces a significant challenge in this regard, as it lacks substantial natural graphite resources. Currently, the majority of the world's graphite supply is concentrated in China and a few other countries, posing potential risks related to supply chain disruptions and economic dependencies.

In terms of graphite production, the primary method has traditionally been the natural mining of geological resources. Unfortunately, the graphite resources available in the United States are limited in quantity, are of low grade, and offer poor commercial value. As a result, there has been a shift towards the production of synthetic graphite. This is predominantly achieved through the processing of carbonaceous materials, such as hydrocarbon sources like coke, using historical methods like the Acheson or Castner furnace designs, which are capital intensive and require high energy consumption. These methods, dating back to the late 18th century, rely on resistive heating for graphitization. More recently, there have been attempts to use coal and biomass as a carbon feedstock, employing pyrolysis as the first step, for graphite production. However, this approach, involves multiple process steps along with lower value byproducts like tars or unstable liquids, and require off-gas clean-up as well.

One significant issue in contemporary graphite production is the technical challenges associated with using methane as a feedstock. Current molten media methods are primarily focused on hydrogen production, with direct graphite production via molten media pyrolysis only beginning to be explored since around 2017. A notable drawback of these methods is that the carbon product often contains entrained salt and metal impurities, which can adversely affect its electrochemical performance, particularly in battery applications. Additionally, carbon deposits can form on all surfaces in contact with the molten liquid, such as reactor walls and tubing, leading to operational inefficiencies and maintenance challenges. Both batch and flow reactor systems present their own unique problems: batch reactors are limited by processing rates, while flow reactors face issues related to thermal management and material flowability when scaled up from laboratory to industrial sizes.

Given these challenges, the field of graphite production is faced with several pressing problems. The reliance on foreign sources for natural graphite poses risks to economic security and supply chain stability. Furthermore, the existing methods for synthetic graphite production are inefficient, often leading to products with impurities that limit their application in high-technology domains. The limitations of current technologies in efficiently processing methane into high-purity graphite underscore the need for innovation in this field.

Accordingly, there is a need for novel methods and systems in graphite production that can overcome these challenges. Innovations that can efficiently convert natural gas, containing methane, into high-purity graphite, while minimizing impurities and operational difficulties, are essential. Such advancements would not only enhance the United States' independence in graphite supply but also support the growing demand in industries reliant on high-quality graphite, such as battery and fuel cell manufacturing. Furthermore, a method that can provide a reliable domestic source of graphite would significantly contribute to national economic security and technological advancement

### SUMMARY OF THE DISCLOSURE

The present disclosure is directed to a method and system for producing graphitic carbon and hydrogen, utilizing a combination of microwave pyrolysis and electrochemical conversion processes. This approach involves transforming methane into amorphous carbon through microwave pyrolysis, followed by carbon pretreatment and then an electrochemical method to convert this pre-treated carbon into graphitic form. In certain embodiments, the system is designed to accommodate various feedstocks, including methane and carbon dioxide, and incorporates the use of carbon-based catalysts and molten salt electrolyte media for the initial, feedstock pyrolysis step.

To address the identified needs in the field of graphite production, this invention introduces an innovative method and system for producing high-purity graphitic carbon, aligning with the increasing demand for reliable and efficient graphite sources. In response to the needs in the field of graphite production, this invention presents a method and system designed to produce high-purity graphitic carbon through an innovative integration of pyrolytic and electrochemical processes. The approach utilizes microwave energy to convert methane into amorphous carbon, which is then transformed into graphitic carbon via electrochemical methods, with some pretreatment of the carbon to make the electrochemical step feasible. This technique offers a modern alternative to traditional resistive heating methods and aims to minimize impurity issues commonly associated with molten media methods.

The design of the system can include the use of carbon-based catalysts and molten salt electrolyte media, with an intent to reduce potential contamination by metal catalysts, often seen in conventional graphite production processes. While this feature is not exclusive or mandatory for the operation of the system, it contributes to enhancing the purity of the produced graphite, potentially making it suitable for applications in sensitive industries like battery and fuel cell manufacturing. Moreover, the system's ability to process various feedstocks, including methane and carbon dioxide, adds a level of versatility and adaptability.

Additionally, the invention contemplates the production of hydrogen as a by-product, which could offer further economic and environmental benefits. In some embodiments, the system may include a recycle of the hydrogen-rich by-product gas to the microwave reactor. In certain embodiments, the system may further utilize a membrane separation system to obtain pure hydrogen gas free from unconverted methane. However, this aspect is not a prerequisite for the system's functionality. Overall, this invention aims to provide a flexible, efficient, and potentially more environmentally friendly method for producing high-quality graphite, supporting the advancement of technological independence and economic security.

In general, in one embodiment, the disclosure features a method for producing graphitic carbon. This method involves generating amorphous or disordered carbon through microwave pyrolysis of a natural gas feedstock in the presence of a carbon catalyst. The amorphous carbon is then treated with an oxidizing agent to introduce oxygen functionalities. Following this treatment, the amorphous carbon is converted to graphitic carbon through electrochemical methods using a cathodic polarization process.

In general, in another embodiment, the disclosure features a system for producing graphitic carbon. This system consists of a microwave pyrolysis reactor configured to receive a natural gas feedstock and containing a carbon catalyst for generating amorphous or disordered carbon. The product stream containing H₂ and some other hydrocarbons, including unused methane, could be recycled and mixed with the methane feed. The system also includes a carbon pre-treatment unit configured to treat the carbon from the microwave pyrolysis unit with an oxidizing agent to introduce oxygen functionalities. Finally, an electrochemical conversion unit equipped with a cathode and graphite anode is provided for converting the treated amorphous carbon to graphitic carbon through a cathodic polarization process.

In general, in another embodiment, the disclosure features a method for pre-treating carbon produced by microwave pyrolysis. This method includes providing amorphous carbon generated from a natural gas feedstock and treating the amorphous carbon with an oxidizing agent selected from the group consisting of permanganate or chlorate, and in the presence of an acid such as nitric acid to introduce oxygen functionalities.

In general, in another embodiment, the disclosure features a method for producing graphitic carbon through direct conversion of carbon dioxide. This method involves providing a system with a cathode equipped with a gas diffusion electrode and an anode with a counter electrode. Carbon dioxide is introduced to the cathode, where it is bubbled through the electrode into a molten salt electrolyte. Cathodic polarization is then performed at the cathode to reduce carbon dioxide to carbon and ion containing oxygen, such as oxide ion, with the carbon being deposited on the cathode.

In general, in another embodiment, the disclosure features a method for producing graphitic carbon through the dissociation of methane in a molten chloride electrochemical cell. This method involves providing an electrochemical cell with a cathode and an anode equipped with a porous gas diffusion electrode. Methane is introduced to the anode, where it is bubbled through the electrode into a molten salt electrolyte. Polarization is then applied to the electrode both anodically and cathodically to facilitate the dissociation of methane into hydrogen and graphitic carbon.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a schematic diagram of a system for producing carbon using microwave pyrolysis, in accordance with certain embodiments of the present disclosure.

FIG. 2 depicts a schematic diagram of a system for producing carbon using electrochemical conversion, in accordance with certain embodiments of the present disclosure.

FIG. 3 depicts a schematic diagram of a process system for the production of carbon and hydrogen by microwave pyrolysis of natural gas and electrochemical conversion, in accordance with certain embodiments of the present disclosure.

FIG. 4 depicts a block diagram of a method for using a process system for the production of carbon and hydrogen by microwave pyrolysis of natural gas and electrochemical conversion, in accordance with certain embodiments of the present disclosure.

FIG. 5 depicts a schematic diagram of a system for the production of carbon from carbon dioxide, in accordance with certain embodiments of the present disclosure.

FIG. 6 depicts a block diagram of a method for using a system for the production of carbon from carbon dioxide, in accordance with certain embodiments of the present disclosure.

FIG. 7 depicts a schematic diagram of a system for the production of carbon from methane, in accordance with certain embodiments of the present disclosure.

FIG. 8 depicts a block diagram of a method for using a system for the production of carbon from methane, in accordance with certain embodiments of the present disclosure.

FIG. 9 depicts a treated carbon black lamellar structure lined with oxygen atoms converted without the carbonyl groups using electrochemical method, in accordance with certain embodiments of the present disclosure.

FIG. 10 depicts oxidized smaller graphene sheets, which are part of the carbon black lamellar structure, that are reduced (deoxygenated) and reordered to form larger sheets of graphite, in accordance with certain embodiments of the present disclosure.

FIG. 11 depicts a schematic of a batch process sequence for microwave pyrolysis, in accordance with certain embodiments of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the terms “amorphous carbon” and “disordered carbon” are used interchangeably to represent the form of carbon that is not graphite but contains lamellar structures that will produce graphite when it is ordered.

### DETAILED DESCRIPTION OF THE DISCLOSURE

The present disclosure is directed to a method and system for producing graphitic carbon and hydrogen, utilizing a combination of microwave pyrolysis, oxidative carbon pre-treatment and electrochemical conversion processes. This approach involves transforming methane into amorphous carbon through microwave pyrolysis, followed by carbon pre-treatment and an electrochemical method to convert this pre-treated carbon into graphitic form. In certain embodiments, the system is designed to accommodate various feedstocks, including methane and carbon dioxide, and incorporates the use of carbon-based catalysts and molten salt electrolyte media.

The disclosure provides innovative, sustainable devices, methods, and systems for monitoring and optimizing processes in carbon conversion and graphitization systems. The present disclosure addresses the challenges and limitations of conventional graphitization methods by introducing an innovative, energy-efficient system for converting disordered carbon into high-purity graphitic carbon. Unlike traditional thermal methods requiring extreme temperatures (˜3000° C.) and significant energy consumption, the disclosed process can integrate processes, such as microwave pyrolysis, oxidative carbon pre-treatment, and electrochemical conversion, to achieve graphitization at substantially lower temperatures. This multifaceted approach is thus, in certain embodiments, able to not only reduce energy requirements but also provides adaptability to diverse feedstocks, such as methane and carbon dioxide, making the system versatile for various industrial applications. Moreover, the electrochemical methods can facilitate precise control over the carbon transformation process, enabling the production of defect-free, high-quality graphite while minimizing environmental impact and operational costs.

In some embodiments, the disclosure not only reduces the temperature and energy requirements for synthetic graphite production but also leverages methane, a readily available component of natural gas, as a feedstock. By co-producing hydrogen—a valuable salable byproduct—in certain embodiments the system further enhances economic viability. The hydrogen produced during the process can also be partially recycled as a green energy source, supporting a closed-loop, energy-efficient system and reducing greenhouse gas emissions associated with synthetic graphite production.

Conversion of disordered forms of carbon, such as carbon black, to graphitic carbon typically requires high temperatures exceeding 3000° C., resulting in substantial energy consumption. Reducing the temperature required for graphitization represents a significant opportunity for energy savings. In certain embodiments of the present disclosure, an electrochemical process can be utilized for converting disordered carbon to graphitic carbon at significantly lower temperatures, thus achieving a more energy-efficient pathway for graphitization.

Carbon black, a disordered carbon form produced through pyrolysis methods, is characterized by its quasi-crystalline structure, in which graphene layers warp over an amorphous core to create spherical aggregates or colloidal-sized particles. This material often contains extensive defects and surface functional groups such as carboxyl (—COOH), carbonyl (═C═O), and hydroxyl (—OH) groups, with oxygen content ranging from 3 to 8 weight percent. When used as a base catalyst in the decomposition of methane, carbon black produces turbostratic carbon-a highly defective form of graphitic carbon.

The electrochemical methods described herein enable the transformation of disordered carbon forms, such as carbon black, into smooth, defect-free graphitic carbon. This process, in some embodiments, begins with the disintegration of carbon black into smaller lamellae, followed by the introduction of oxygen functionalities, predominantly carbonyl groups, at the edges.

In some embodiments, the first step, represented by the reaction below, involves oxidative treatment to introduce carbonyl groups:

C(D,Solid)→C═O(D,Solid)

In some embodiments, in a subsequent step, the oxygenated structures may undergo electrochemical reduction, which removes the oxygen groups and facilitates the reordering of carbon atoms into larger, more ordered graphene sheets. This conversion, as shown below, results in the formation of graphitic carbon:

C═O(D,Solid)=>C(G,Solid)

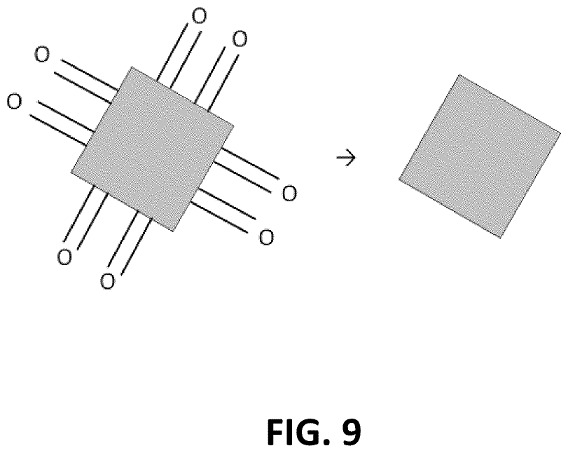

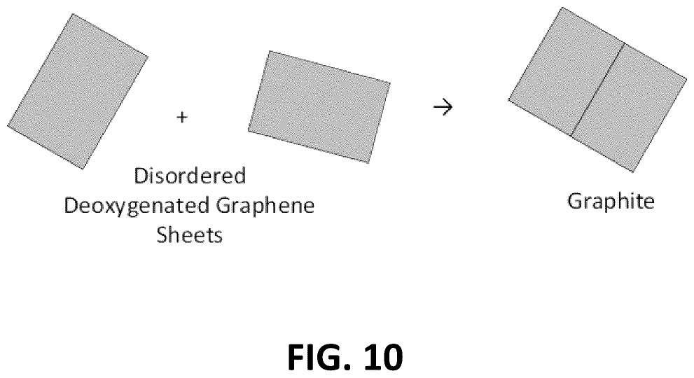

FIG. 9 illustrates the intermediate lamellar structure of treated carbon black, with oxygen atoms lining the edges. These structures are converted into larger graphite sheets during the electrochemical reduction process, as depicted in FIG. 10. The removal of oxygen groups not only promotes the formation of extensive graphite sheets but also generates oxide ions (O²⁻) as reaction byproducts.

The process involves significant changes in energy, including a reduction in edge energy due to decreased interactions between individual lamellae and a reduction reaction associated with the removal of carbonyl groups. The energy change for reordering lamellae is described by the equation:

$$Δ G = {W}_{cc} ( {C}_{g , b} - {C}_{cb , e} )$$

In the equation above, W_{cc} represents the pairwise interaction energy between carbon atoms, while C_{cb,e} and C_{g,b} denote the coordination numbers for edge and bulk carbon atoms, respectively. Based on thermodynamic data, the free energy change associated with this reordering process is calculated to be approximately −239 KJ/mol, indicating that the reordering is thermodynamically favorable.

In embodiments of the present disclosure, the reduction of carbonyl groups to carbon can be modeled using the following reaction:

>C=O(D,Solid)+2e⁻→C(G,Solid)+O²⁻

The free energy change for this reaction, based on bond energies and experimental data, is calculated to correspond to an electrochemical potential of approximately −1.6 V, aligning with observed cathodic polarization behavior for carbon black.

The overall process, encompassing both the reduction of carbonyl groups and the reordering of carbon atoms, in such embodiments, results in a net free energy change of approximately −43.8 KJ/mol. This negative value underscores the feasibility of using electrochemical methods to achieve graphitization of disordered carbon at temperatures significantly lower than traditional thermal methods (˜3000° C.). The proposed system of embodiments of the present disclosure, therefore, can provide a sustainable and energy-efficient solution for producing high-purity graphitic carbon from disordered precursors.

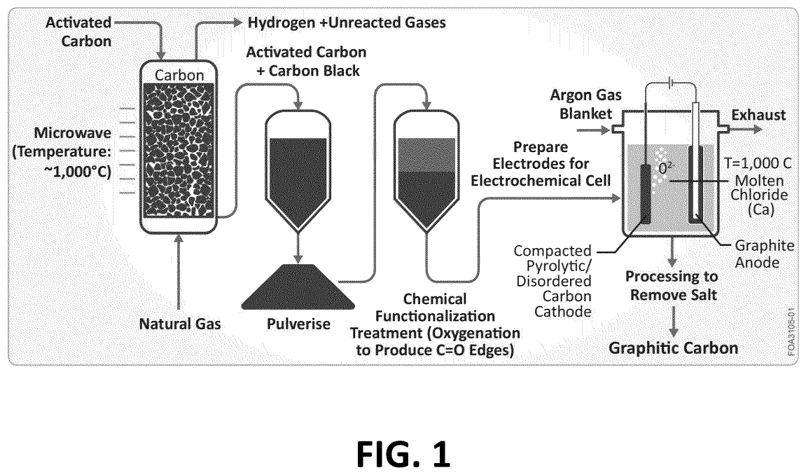

Accordingly, in certain embodiments of the present disclosure, a novel method and system are described for producing graphitic carbon and hydrogen. This invention integrates a pyrolytic process using microwave heat delivery with electrochemical methods to convert amorphous carbon into graphitic carbon. The system is designed to be adaptable, capable of processing either carbon dioxide or methane feedstocks. FIG. 1 depicts a schematic diagram of a system for producing graphitic carbon using microwave pyrolysis, in accordance with certain embodiments of the present disclosure.

In some embodiments, the production of amorphous carbon is achieved through the microwave pyrolysis of a natural gas feedstock. This pyrolysis is conducted in the presence of a carbon catalyst. For example, in embodiments where the natural gas feedstock primarily comprises methane, the system can be optimized for this specific feed composition. The carbon catalyst in some embodiments could be a fluidized bed of carbon particles, offering efficient heat transfer and reaction kinetics.

In exemplary embodiments, the amorphous carbon produced through microwave pyrolysis is treated with an oxidizing agent to introduce oxygen functionalities. The oxidizing agent can be chosen from one of either a permanganate or chlorate along with acid treatment using either nitric acid or sulfuric acid to lower the pH. The treatment process may be tailored to optimize the introduction of oxygen functionalities and may be performed at specific temperature ranges conducive to efficient oxidation. In certain embodiments, the treated amorphous carbon is washed to remove excess oxidizing agent.

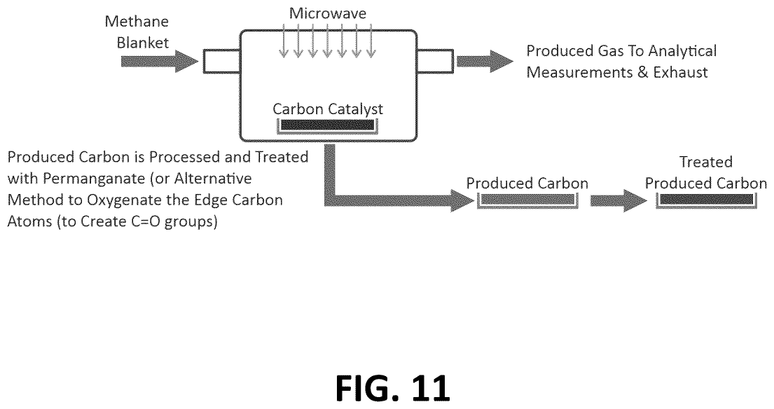

FIG. 11 depicts a schematic of a batch process sequence for microwave pyrolysis, in accordance with certain embodiments of the present disclosure. As shown in FIG. 11, the system can include a microwave-based quartz tube reactor containing a carbon catalyst. Methane can be introduced into the reactor under a controlled blanket, where it undergoes microwave pyrolysis to produce amorphous carbon and a gas byproduct stream directed toward analytical measurement and exhaust. The produced amorphous carbon, as shown in FIG. 11, can then be subjected to chemical treatment with an oxidizing agent, such as permanganate, to oxygenate the edge carbon atoms, forming C═O (carbonyl) groups. In such embodiments, this treatment step enhances the carbon structure in preparation for electrochemical processing.

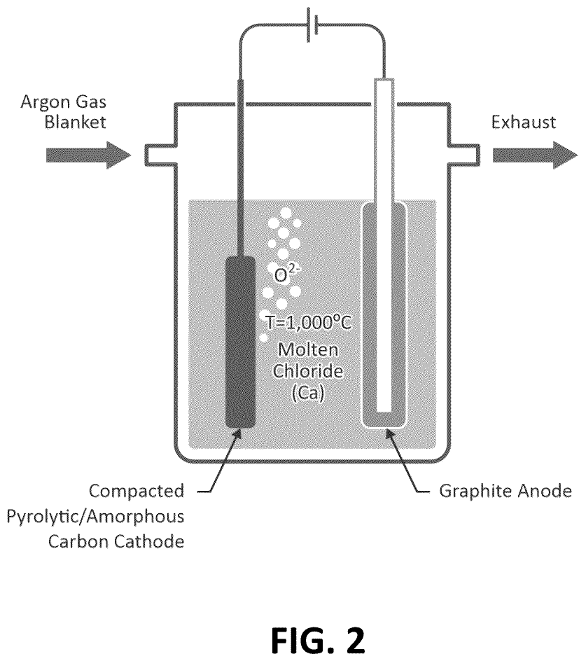

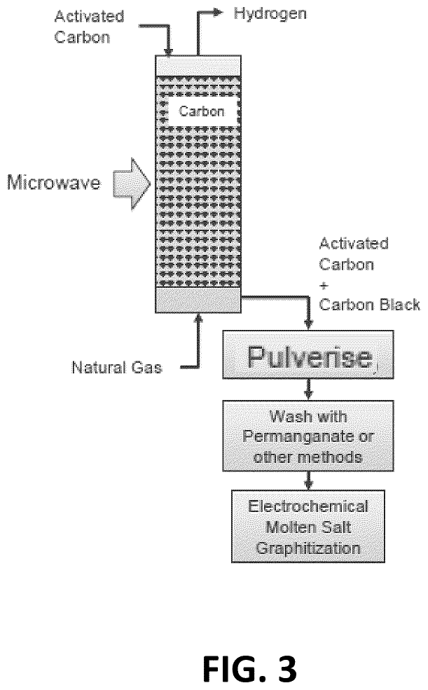

As depicted in FIG. 2 and FIG. 3, the system includes an electrochemical conversion unit. In some embodiments, the amorphous carbon treated with oxidizing agents is further processed in the electrochemical conversion unit to facilitate conversion into graphitic carbon, utilizing a cathodic polarization process. The electrolyte used in this process in some embodiments comprises molten alkali earth metal chloride or carbonates. In such embodiments, the electrochemical cell can be a molten salt system operating under batch conditions. In certain embodiments, a graphite anode is used in the electrochemical conversion process. The entire electrochemical conversion process could be conducted under an inert gas blanket, such as argon, to maintain a controlled environment.

In certain embodiments, the system is designed for continuous processing. This may include a fluidized bed reactor for the production of amorphous carbon and an electrochemical reactor for the conversion to graphite.

In exemplary embodiments, the system and method are adaptable to alternative feedstocks, including carbon dioxide, in addition to methane. This adaptability enhances the versatility of the method and system, making it suitable for various industrial applications.

In the electrochemical cell, in some embodiments, the cathode can include amorphous carbon selected from suitable carbon black materials with lamellar disordered structures. In the electrochemical cell, in some embodiments, the anode can be composed of graphite or metal to facilitate oxidation of oxide ions. Molten alkali earth metal chloride, such as for example, but not limited to calcium or sodium chloride, serves as the electrolyte. Under cathodic polarization, graphitization of the carbon can occur, while oxide ions migrate to the anode, either accumulating or oxidizing to a reaction product. In certain embodiments, the cell is designed to operate under an argon gas blanket to remove reaction products and maintain inert conditions.

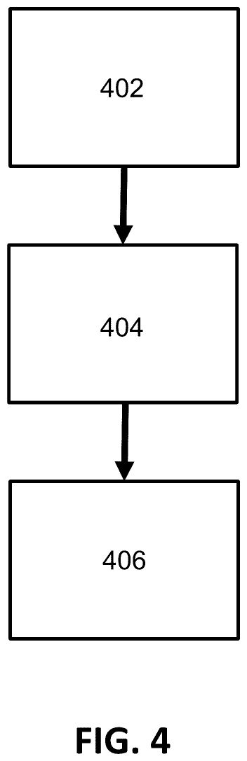

As depicted in FIG. 4, the block diagram illustrates a method for using a process system for the production of carbon and hydrogen by microwave pyrolysis of natural gas and electrochemical conversion, in accordance with certain embodiments of the present disclosure. Block 402 involves generating amorphous carbon by microwave pyrolysis. Following, the treatment of the amorphous carbon with an oxidizing agent, is shown as block 404. Finally, the conversion of the treated amorphous carbon to graphitic carbon via electrochemical methods is depicted as block 406.

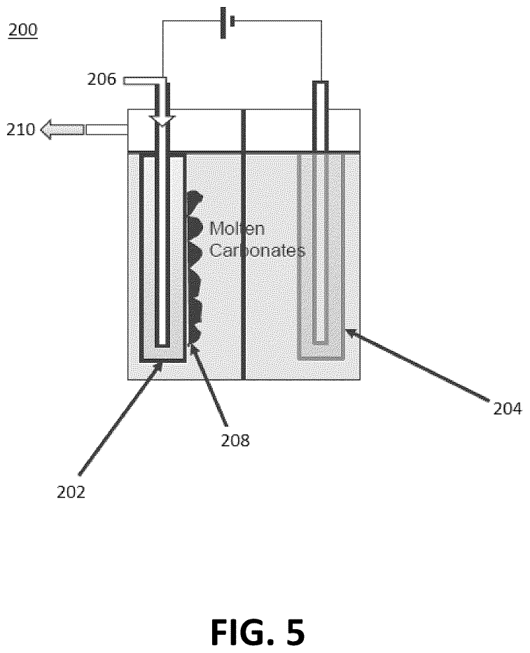

Further, the present disclosure describes a method for producing graphitic carbon through the direct conversion of carbon dioxide in certain embodiments. This process involves the use of a specialized system comprising a cathode equipped with a gas diffusion electrode and an anode with a counter electrode. Carbon dioxide is introduced into this system and subjected to specific electrochemical processes to achieve the desired conversion. FIG. 5 depicts a schematic diagram of a system for the production of carbon from carbon dioxide, in accordance with certain embodiments of the present disclosure.

As illustrated in FIG. 5, the system, designated as 200, includes a gas diffusion electrode 202 located at the cathode side. Carbon dioxide 206 is introduced into this system. The product gases 210, which may include unreacted carbon dioxide, are released as an outlet from the system. On the cathode side, where the gas diffusion electrode 202 is located, a carbon product 208 is formed. The system also comprises a counter electrode 204 on the anode side, which in certain embodiments, can be made of various materials including metals and carbon-based electrodes.

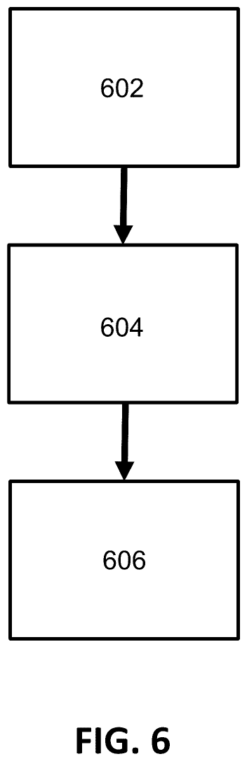

FIG. 6 depicts a block diagram of a method for using a system for the production of carbon from carbon dioxide, in accordance with certain embodiments of the present disclosure. Specifically, referring to FIG. 6, the method for using this system is depicted in a block diagram. Block 602 represents the provision of a system with a cathode equipped with a gas diffusion electrode and an anode with a counter electrode. Block 604 involves introducing carbon dioxide to the cathode, where the carbon dioxide is bubbled through the electrode into a molten salt electrolyte. The electrolyte can comprise one or more of molten metal carbonates and molten metal chlorides. Block 606 illustrates performing cathodic polarization at the cathode to reduce carbon dioxide to carbon and oxygen containing ion, such as an oxide ion, where the carbon is deposited on the cathode.

In certain embodiments, the electrolyte used in this process may include molten metal carbonates or chlorides, providing a conducive environment for the electrochemical reactions. The cathodic polarization at the cathode is conducted at temperatures below 1000 degrees Celsius, which is crucial for the efficiency and quality of the resulting graphitic carbon.

In certain embodiments, the gas diffusion electrode at the cathode is integral in facilitating the reduction of carbon dioxide to carbon and oxygen. The process also encompasses capturing unreacted gaseous oxygen as a byproduct, which is a crucial aspect of the overall process efficiency. Additionally, the system may operate under an argon gas blanket, which creates an inert atmosphere during the reduction process, thereby enhancing the reaction's stability and safety.

In some embodiments, the method involves analyzing the carbon product formed on the cathode. This analysis aims to assess the efficiency and quality of the graphite production, providing valuable insights into the process efficacy and the characteristics of the produced graphite. Furthermore, in certain embodiments, carbon dioxide is continuously admitted to the working electrode during the process. This continuous admission ensures a steady and consistent supply of feedstock for the reaction, which is vital for maintaining the efficiency and continuity of the process.

In certain embodiments of the present disclosure, a method is described for producing graphitic carbon through the dissociation of methane in a molten chloride electrochemical cell. This process involves the use of an electrochemical cell equipped with a cathode and an anode, where the anode includes a porous gas diffusion electrode. The method focuses on the dissociation of methane to produce hydrogen and graphitic carbon.

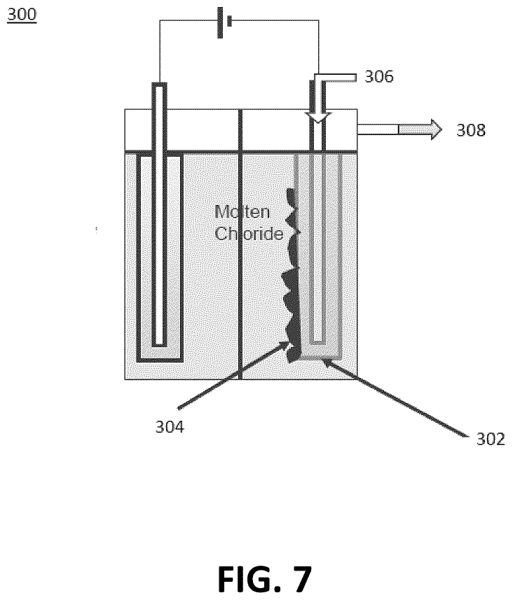

As shown in FIG. 7, the system, designated as 300, incorporates a gas diffusion electrode 302 situated on the anode side. Methane 306 is introduced into the system, and the resultant products, including hydrogen gas, or dissolved hydrogen ion, and unreacted methane 308, are discharged. On the anode side, where the gas diffusion electrode 302 is located, a carbon product 304 is formed, signifying the successful dissociation of methane.

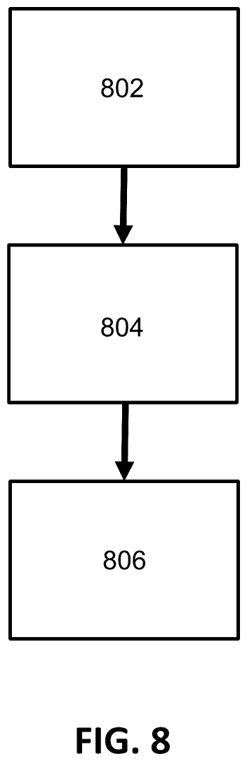

Referring to FIG. 8, the method for using this system is depicted. Block 802 represents the provision of an electrochemical cell with a cathode and an anode equipped with a porous gas diffusion electrode. Block 804 involves introducing methane to the anode, where it is bubbled through the electrode into a molten salt electrolyte. The electrolyte may consist of molten alkali earth metal chloride or carbonates. Block 806 illustrates applying polarization to the electrode both anodically and cathodically to facilitate the dissociation of methane into hydrogen, or dissolved hydrogen ion, and graphitic carbon.

In some embodiments, the porous gas diffusion electrode at the anode is made of nickel or a carbon-based material. The choice of electrode material can significantly impact the efficiency of the methane dissociation process. Furthermore, controlling the temperature of the electrochemical cell can be used to optimize the dissociation process.

The method may also include capturing the hydrogen produced as a byproduct of the methane dissociation process. Adjusting the polarization applied to the electrode can be used to maximize the production of hydrogen and graphitic carbon. The system's operation under an argon gas blanket can allow for an inert atmosphere, enhancing the reaction's safety and stability. In certain embodiments, the method includes collecting and analyzing the produced graphitic carbon to assess its quality and purity.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that although the previous paragraphs relate to embodiments where steps may be described as occurring in a certain order, no ordering is required unless otherwise stated. In fact, steps described in the previous paragraphs may occur in any order. Furthermore, although one step may be described in one figure and another step may be described in another figure, embodiments of the present disclosure are not limited to such combinations, as any of the steps described above may be combined in particular embodiments.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

Clause 1. A method for producing graphitic carbon by generating amorphous carbon through microwave pyrolysis of a natural gas feedstock in the presence of a carbon catalyst, treating the amorphous carbon with an oxidizing agent to introduce oxygen functionalities, and converting the treated amorphous carbon to graphitic carbon through electrochemical methods.

Clause 1.1. A method for producing graphitic carbon, the method including performing oxidative pre-treatment of an amorphous carbon with an oxidizing agent to introduce oxygen functionalities, and converting the treated amorphous carbon to graphitic carbon through electrochemical methods.

Clause 2. The method of any foregoing clause, where the natural gas feedstock primarily comprises methane.

Clause 3. The method of any foregoing clause, where the oxidizing agent is permanganate or chlorate in the presence of nitric acid or sulfuric acid.

Clause 3.1. The method of any foregoing clause, wherein the chemical agent used for chemical treatment comprises permanganate, chlorate, or combinations thereof in acidic pH conditions or simply exposing the disordered carbon to excess oxygen.

Clause 3.2. The method of any foregoing clause, where the treatment with a chemical agent introduces oxygen dominant functional groups comprising any one of carbonyl, carboxyl or ketones, on the produced disordered carbon.

Clause 4. The method of any foregoing clause, where the carbon catalyst is a fluidized bed of carbon particles.

Clause 5. The method of any foregoing clause further including using a graphite anode in the electrochemical conversion process.

Clause 6. The method of any foregoing clause further including the use of an electrolyte comprising molten alkali earth metal chloride or carbonates.

Clause 7. The method of any foregoing clause further including characterizing the produced amorphous carbon as a function of feed composition and temperature.

Clause 8. The method of any foregoing clause, where the electrochemical conversion is conducted under an inert gas blanket, such as argon.

Clause 9. The method of any foregoing clause, where the carbon catalyst is used to facilitate the dissociation of methane into carbon and hydrogen.

Clause 10. The method of any foregoing clause further including designing the system for continuous processing, including a fluidized bed reactor for production of amorphous carbon and an electrochemical reactor for conversion to graphite.

Clause 11. The method of any foregoing clause, where the production of graphitic carbon is adaptable to alternative carbon dioxide feedstock in addition to methane.

Clause 12. A system for producing graphitic carbon consisting of a microwave pyrolysis reactor configured to receive a natural gas feedstock and containing a carbon catalyst for generating amorphous carbon, an oxidizing unit configured to treat the amorphous carbon with an oxidizing agent to introduce oxygen functionalities, and an electrochemical conversion unit equipped with a cathode for converting the treated amorphous carbon to graphitic carbon through a cathodic polarization process.

Clause 13. The system of any foregoing clause, where the microwave pyrolysis reactor is specifically designed for processing methane as the primary component of the natural gas feedstock.

Clause 14. The system of any foregoing clause, where the oxidizing agent is selected from the group consisting of permanganate or chlorate.

Clause 14.1. The system of any foregoing clause, wherein the system is operable to oxide the amorphous carbon by exposure to oxygen rich atmosphere or oxygen ions.

Clause 15. The system of any foregoing clause, where the carbon catalyst within the microwave pyrolysis reactor includes a fluidized bed of carbon particles.

Clause 16. The system of any foregoing clause, where the electrochemical conversion unit is equipped with a graphite anode.

Clause 17. The system of any foregoing clause, where the electrochemical conversion unit utilizes an electrolyte selected from the group consisting of molten alkali earth metal chlorides and carbonates.

Clause 17.1. The system of any foregoing clause, wherein the electrochemical conversion unit further comprises a metal anode operable to facilitate oxygen gas production.

Clause 18. The system of any foregoing clause further including a characterization unit designed for analyzing the produced amorphous carbon based on feed composition and temperature.

Clause 19. The system of any foregoing clause, where the electrochemical conversion unit is operated under an inert gas blanket, such as argon, to maintain a controlled environment.

Clause 20. The system of any foregoing clause, where the carbon catalyst in the microwave pyrolysis reactor is used for facilitating the dissociation of methane into carbon and hydrogen.

Clause 21. The system of any foregoing clause further including designing for continuous operation, includes a fluidized bed reactor for producing amorphous carbon and an electrochemical reactor for converting this carbon to graphite.

Clause 22. A method for treating amorphous carbon produced by microwave pyrolysis by providing amorphous carbon generated from a natural gas feedstock and treating the amorphous carbon with an oxidizing agent selected from the group consisting of permanganate, chlorate, and nitric acid to introduce oxygen functionalities.

Clause 22.1. The method of any foregoing clause, further comprising the treatment of amorphous carbon by exposure to oxygen rich atmosphere.

Clause 22.2. The method of any foregoing clause, further comprising the treatment of amorphous carbon by exposure to oxygen ions.

Clause 23. The method of any foregoing clause, where the natural gas feedstock primarily comprises methane.

Clause 24. The method of any foregoing clause, where the oxidizing agent is permanganate.

Clause 25. The method of any foregoing clause, where the oxidizing agent is chlorate.

Clause 26. The method of any foregoing clause, where the pH lowering agent is nitric acid or sulfuric acid.

Clause 27. The method of any foregoing clause further including controlling the concentration of the oxidizing agent to optimize the introduction of oxygen functionalities.

Clause 28. The method of any foregoing clause, where the treatment with the oxidizing agent is performed at a temperature range conducive to the efficient introduction of oxygen functionalities.

Clause 29. The method of any foregoing clause further including a subsequent step of washing the treated amorphous carbon to remove excess oxidizing agent.

Clause 30. The method of any foregoing clause, where the treated amorphous carbon is further processed to convert it into graphitic carbon.

Clause 31. The method of any foregoing clause, where the oxygen functionalities introduced are primarily C═O groups.

Clause 32. A method for producing graphitic carbon through direct conversion of carbon dioxide by providing a system with a cathode equipped with a gas diffusion electrode and an anode with a counter electrode, introducing carbon dioxide to the cathode where it is bubbled through the electrode into a molten salt electrolyte, and performing cathodic polarization at the cathode to reduce carbon dioxide to carbon and oxygen containing ion, such as an oxide ion, wherein the carbon is deposited on the cathode.

Clause 33. The method of any foregoing clause, where the molten salt electrolyte comprises one or more of molten metal carbonates and molten metal chlorides.

Clause 34. The method of any foregoing clause further including operating the system under an argon gas blanket.

Clause 35. The method of any foregoing clause, where the cathode is a nickel electrode.

Clause 36. The method of any foregoing clause, where the electrolyte is selected from a group consisting of molten metal carbonates.

Clause 37. The method of any foregoing clause, where the electrolyte is selected from a group consisting of molten metal chlorides.

Clause 38. The method of any foregoing clause, where the cathodic polarization at the cathode is conducted at temperatures below 1000 degrees Celsius.

Clause 39. The method of any foregoing clause further including testing different materials for the counterelectrode (anode), including other metals and carbon-based electrodes.

Clause 40. The method of any foregoing clause, where the gas diffusion electrode at the cathode facilitates the reduction of carbon dioxide to carbon and oxygen.

Clause 41. The method of any foregoing clause further including the step of capturing unreacted gaseous oxygen as a byproduct of the reaction.

Clause 42. The method of any foregoing clause, where the argon gas blanket is maintained to create an inert atmosphere during the reduction process.

Clause 43. The method of any foregoing clause further including the analysis of the carbon product formed on the cathode to assess the efficiency and quality of graphite production.

Clause 44. The method of any foregoing clause, where the carbon dioxide is admitted continuously to the working electrode during the process.

Clause 45. A method for producing graphitic carbon through the dissociation of methane in a molten chloride electrochemical cell by providing an electrochemical cell with a cathode and an anode equipped with a porous gas diffusion electrode, introducing methane to the anode where it is bubbled through the electrode into a molten salt electrolyte, and applying polarization to the electrode both anodically and cathodically to facilitate the dissociation of methane into hydrogen ion, which can be reduced to hydrogen gas, and graphitic carbon.

Clause 46. The method of any foregoing clause, where the molten salt electrolyte consists of molten alkali earth metal chloride.

Clause 47. The method of any foregoing clause, where the molten salt electrolyte consists of molten alkali earth metal carbonates.

Clause 48. The method of any foregoing clause, where the porous gas diffusion electrode at the anode is made of nickel.

Clause 49. The method of any foregoing clause, where the porous gas diffusion electrode at the anode is made of a carbon-based material.

Clause 50. The method of any foregoing clause further including controlling the temperature of the electrochemical cell to optimize the dissociation process.

Clause 51. The method of any foregoing clause, where the polarization applied to the electrode is adjusted to maximize the production of hydrogen and graphitic carbon.

Clause 52. The method of any foregoing clause further including capturing the hydrogen produced as a byproduct of the methane dissociation process.

Clause 53. The method of any foregoing clause further including the step of collecting and analyzing the produced graphitic carbon to assess its quality and purity.

Clause 54. The method of any foregoing clause, where the electrochemical cell is operated under an argon gas blanket to maintain an inert atmosphere.

Clause 55. The method of any foregoing clause further including analyzing the efficiency of methane conversion to graphitic carbon and hydrogen.

### REFERENCES

Abanedes et al., Int. J. of Hydr. Energy, 2016.
Asenbauer et al., Sustainable Energy Fuels, 2020.
Bradley, R. H.; Pendleton, P. Structure, Chemistry and Energy of Carbon Surfaces. Adsorption Science & Technology 2013, 31 (2-3), 113-133. DOI: 10.1260/0263-6174.31.2-3.113.
Chase, M. W. NIST-JANAF Thermochemical Tables for Oxygen Fluorides. Journal of Physical and Chemical Reference Data 1996, 25 (2), 551-603. DOI: 10.1063/1.555992.
Chase M. W. NIST-JANAF Thermochemical Tables for Oxygen Fluorides. Journal of Physical and Chemical Reference Data 1998.
Federal Register/Vol. 87, No. 37/Thursday, Feb. 24, 2022.
Geißler et al. Chem. Eng. J. 299 (2016) 192-200.
Guil-Lopez, R.; Botas, J. A.; Fierro, J. L. G.; Serrano, D. P. Comparison of metal and carbon catalysts for hydrogen production by methane decomposition. Applied Catalysis A: General 2011, 396 (1), 40-51.
Gupta, R.; Raman, S.; Caram, H. S.; Dankworth, D. C. Systems and processes for molten media pyrolysis. Google Patents: 2023.
Jager, H.; Frohs, W.; Collin, G.; von Sturm, F.; Vohler, O.; Nutsch, G. Carbon, 1. General. In Ullmann's Encyclopedia of Industrial Chemistry.
Ji, Y., et al. Carbon 204 (2023) 26-35.
Jiang, C., I. W. Wang, X. Bai, S. Balyan, B. Robinson, J. Hu, W. Li, A. Deibel, X. Liu, F. Li, L. M. Neal, J. Dou, Y. Jiang, R. Dagle, J. A. Lopez-Ruiz, and G. Skoptsov. 2022. “Methane Catalytic Pyrolysis by Microwave and Thermal Heating over Carbon Nanotube-Supported Catalysts: Productivity, Kinetics, and Energy Efficiency.” Industrial & Engineering Chemistry Research 61 (15): 5080-5092.
Jin et al., Chem. Eur. J., 2017.
Khodabakhshi et al., Carbon, 2020.
Khodabakhshi, S.; Fulvio, P. F.; Andreoli, E. Carbon black reborn: Structure and chemistry for renewable energy harnessing. Carbon 2020, 162, 604-649.
Lantelme, F., Kaplan, B, Groult, H., and Devilliers; Mechanism for Elemental Carbon Formation in Molecular Liquids, Journal of Molecular Liquids 1999, 83, 255-269.
McFarland, E. W.; Upham, C.; Palmer, C.; Su, S.; Mannini, D.; Rahimi, N.; Kang, D.; Metiu, H.; Gordon, M. Natural gas conversion to chemicals and power with molten salts. Google Patents: 2021.
Peng, J.; Chen, N.; He, R.; Wang, Z.; Dai, S.; Jin, X. Electrochemically Driven Transformation of AmorphousCarbons to Crystalline Graphite Nanoflakes: A Facile and Mild Graphitization Method. Angewandte Chemie International Edition 2017, 56 (7), 1751-1755.
Pomfret et al., The Journal of Physical Chemistry C, 2008.
Robinson et al., USGS Report, 2017.
Ruz, P.; Banerjee, S.; Pandey, M.; Sudarsan, V.; Sastry, P. U.; Kshirsagar, R. J. Structural evolution of turbostratic carbon: Implications in H2 storage. Solid State Sciences 2016, 62, 105-111.
Ullman's Encyclopedia, Industrial Carbons, 2012.
Wang, C. W., Canhui; Xie, Penfei; Hu, Liangbing; Dong, Qi; Li, Tangyuan; Arias-Monje, Pedro; Jony, Bodiuzzman; Gupta, Kishor; Kumar, Satish. Systems, methods, and devices for carbon material upgrade and organic compound pyrolysis. United States 2022.
Yap et al., MDPI Materials, 2023. Zhang, Liang, and Dunn, Env. Sci. Tech., 2023.

What is claimed is:

1. A method for producing graphitic carbon, comprising:
(a) generating amorphous or disordered carbon by microwave pyrolysis of a natural gas feedstock in the presence of a carbon catalyst;
(b) treating the amorphous carbon with an oxidizing agent to introduce oxygen functionalities; and
(c) converting the treated amorphous carbon to graphitic carbon through electrochemical methods using a cathodic polarization process.

2. The method of claim 1, wherein the natural gas feedstock primarily comprises methane.

3. The method of claim 1, wherein the carbon catalyst is a fluidized bed of carbon particles.

4. The method of claim 1, wherein the treatment with a chemical agent introduces oxygen dominant functional groups comprising any one of carbonyl, carboxyl or ketones, on the produced disordered carbon.

5. The method of claim 1, wherein the chemical agent used for chemical treatment comprises permanganate, chlorate, or combinations thereof in acidic pH conditions.

6. The method of claim 1, wherein the electrochemical methods include the use of an electrolyte comprising molten alkali earth metal chloride or carbonates.

7. The method of claim 1, wherein the electrochemical conversion process further involves using a graphite anode.

8. The method of claim 1, further comprising a step of characterizing the produced amorphous carbon as a function of feed composition and temperature.

9. The method of claim 1, wherein the electrochemical conversion is conducted under an inert gas blanket, such as argon.

10. The method of claim 1, wherein the carbon catalyst is used to facilitate the dissociation of methane into carbon and hydrogen.

11. The method of claim 1, wherein the system is designed for continuous processing, including a fluidized bed reactor for production of amorphous carbon and an electrochemical reactor for conversion to graphite.

12. The method of claim 1, wherein the production of graphitic carbon is adaptable to alternative carbon dioxide feedstock in addition to methane.

13. A system for producing graphitic carbon, comprising:
(a) a microwave pyrolysis reactor configured to receive a natural gas feedstock and containing a carbon catalyst for generating amorphous carbon;
(b) an oxidizing unit configured to treat the amorphous carbon with an oxidizing agent to introduce oxygen dominant chemical functionalities; and
(c) an electrochemical conversion unit equipped with a cathode for converting the treated amorphous carbon to graphitic carbon through a cathodic polarization process.

14. The system of claim 13, wherein the microwave pyrolysis reactor is specifically designed for processing methane as the primary component of the natural gas feedstock.

15. The system of claim 13, wherein the oxidizing agent is selected from the group consisting of permanganate, chlorate, nitric acid, or combinations thereof.

16. The system of claim 13, wherein the carbon catalyst within the microwave pyrolysis reactor includes a fluidized bed of carbon particles.

17. The system of claim 13, wherein the electrochemical conversion unit is equipped with a graphite anode.

18. The system of claim 13, wherein the electrochemical conversion unit utilizes an electrolyte selected from the group consisting of molten alkali earth metal chlorides and carbonates.

19. The system of claim 13, further comprising a characterization unit designed for analyzing the produced amorphous carbon based on feed composition and temperature.

20. The system of claim 13, wherein the electrochemical conversion unit is operated under an inert gas blanket, such as argon, to maintain a controlled environment.

21. The system of claim 13, wherein the carbon catalyst in the microwave pyrolysis reactor is used for facilitating the dissociation of methane into carbon and hydrogen.

22. The system of claim 13, designed for continuous operation, includes a fluidized bed reactor for producing amorphous carbon and an electrochemical reactor for converting this carbon to graphite.
